(19) United States
(12) Patent Application Publication
(10) Pub. No.: US 2024/0181373 A1
(43) Pub. Date: Jun. 6, 2024

(54) PLANT AND PROCESS FOR REMOVING SUSPENDED SOLIDS, OILS AND GREASES FROM COOLING WATER IN THE STEEL AND METALLURGICAL SECTOR

(71) Applicant: DANIELI & C. OFFICINE MECCANICHE S.P.A., Buttrio (UD) (IT)

(72) Inventors: Antonio NARDELLA, Greve in Chianti (FI) (IT); Valentino VISINTIN, Mariano del Friuli (GO) (IT)

(21) Appl. No.: 18/553,453

(22) PCT Filed: Mar. 31, 2022
(86) PCT No.: PCT/IB2022/052995

§ 371 Date: Sep. 29, 2023

(30) Foreign Application Priority Data
Apr. 1, 2021 (IT) 102021000008330

(51) Int. Cl. B01D 21/00; B01D 17/02; B01D 17/04; B01D 21/24; C02F 1/00; C02F 1/40; C02F 1/48; C02F 101/20; C02F 101/32; C02F 103/16

(52) U.S. Cl. CPC B01D 21/0051; B01D 17/0214; B01D 17/045; B01D 21/0009; B01D 21/0045; B01D 21/2438; B01D 21/245; C02F 1/40; C02F 1/488; B01D 21/0006; C02F 2001/007; C02F 2101/203; C02F 2101/32; C02F 2103/16; C02F 2201/007; C02F 2301/022; C02F 2303/22

(57) ABSTRACT

The invention relates to a water treatment line and a process for removing suspended solids, such as ferrous scale, and in particular also oils and greases, from cooling waters of metallurgical or steel processing. A sedimentation tank is included in which there is a lamellar pack filter with inclined sedimentation surfaces comprising a plurality of adjacent, essentially parallel and inclined tubular profiles, in particular with an angle of inclination with respect to the bottom of said tank of 50-65°. The application of the laminar packs in the tank which separate suspended solids, in particular ferrous scale, by sedimentation avoids the use of sand filters or the like.

### TECHNICAL FIELD

The present invention relates to a device, in particular a water treatment line and a relative method for removing suspended solids from fluids, in particular metal scale from cooling waters used in metallurgical and steel plants. The removal is based on sedimentation effects; preferably it is accompanied by the elimination of oils and greases from the water.

### BACKGROUND ART

The final removal of suspended solids and oils/greases leaving longitudinal settlers in rolling mill circulation water treatment is achieved by means of sand filters, a widely established technique and belonging to BAT (Best Available Technologies), and for example described in WO 2008/049833 A2 of the same applicant. Sand filters suffer from several disadvantages: they are subjected to the formation of surface crusts with frequent filter clogging phenomena and consequent frequent backwash operations, do not allow the achievement of high filtration speeds and therefore require a large number of filtering units, they also require a layer of anthracite above the sand layer to eliminate oils and greases and therefore entail high investment and maintenance costs. In particular, state-of-the-art filtration systems are characterized by high costs for the filtration material used and for the construction of the civil works necessary to create the foundations of the filters and for the longitudinal settlers of considerable dimensions, which have the function of preparing the water for filtration; costs are added for auxiliary elements such as automatic valves, backwash pumps, blowers, for the transport of oversized filters in general, for on-site assembly, as well as the costs for treating the sludge coming from the backwash of the filters themselves. Therefore, high operating expenses (OPEX) and capital costs (CAPEX) must be faced in each filtration system.

Other documents, GB 2 179 869 A and GB 2 275 210 A, describe the use of lamellar filters for scale separation.

### SUMMARY OF THE INVENTION

The object of the invention is to overcome the aforesaid drawbacks and to propose a system, in particular a water treatment line, and a relative process for removing suspended solids and preferably also oils and greases from liquids, in particular the metal scale from cooling waters coming from metallurgical or steel processes.

The term scale in the steel sector comprises several types of materials, in particular all the components are intended which can detach from a product which is processed due to oxidation and/or processing actions, including metal or ferrous oxide particles.

Further objects or advantages of the invention will be apparent from the following description.

In a first aspect of the invention, the object is achieved by a water treatment line as defined in the first claim comprising a device for removing suspended solids from liquids, in particular from water comprising:
(a) a sedimentation tank with a solids collection sector;
(b) in said tank a lamellar pack filter with sedimentation surfaces inclined with respect to the bottom of said tank;
(c) in said tank a system for conveying the solids leaving said lamellar pack filter into said collection sector; and
(d) a device configured to extract the solids from said solids collection sector, wherein the lamellar pack filter comprises a plurality of adjacent, essentially parallel and inclined tubular profiles, in particular with an angle of inclination with respect to the bottom of said sedimentation tank of 50-65°, in particular of about 60°.

The state of the art knows from the oil and chemical sector the application of lamellar filters to separate oils and greases, often in connection with the use of classic filtering systems by passing the liquid to be filtered through filtering means, such as sand, polymer particles, to remove solids. Lamellar packs for separating oils and greases are filters of the type CPI (Corrugate Plate Interceptor) or of the type TPI (Tiltable Plate Interceptor), i.e., lamellar packs in which the separation occurs through the use of inclined plates (TPI) or coalescing planes (CPI), which have parallel corrugated planes.

The use of CPI/TPI packs is common in deoiling in petrochemical processes in substitution or in conjunction with common API (American Petroleum Institute Standard) separators which exploit the different density between oils, water, and solids, in which the oil floats, the solids deposit on the bottom, and the water remains in between in the longitudinal sedimentation tanks. The classic lamellar packs consist of a series of corrugated slabs (corrugated in CPIs and straight in TPIs), arranged in parallel and enclosed by a frame and inclined by 45-60° with respect to the horizontal component, i.e., the bottom of the settler.

The oily particles dispersed due to the ascending component of Stokes' law are intercepted by the corrugated slabs, avoiding being dragged by the main current which flows through the pack from top to bottom with laminar motion. The oily particles are collected on the top of the undulations and stratified on the surface of the tank to then be evacuated by adjustable skimmers. The suspended solids are collected on the bottom and then evacuated with augers or pumps.

Document U.S. Pat. No. 5,938,935 aimed at purifying and treating cooling waters or lubricants in the metallurgical industry to separate scale from the process water of cooling circuits, excludes the use of lamellar filters as described above for separating metal scale, since according to the authors they do not provide a sufficient degree of purity. The document therefore departs from the invention. To avoid the use of sand or gravel filters, it instead proposes a system with horizontal slats which have a magnetic upper surface and which are in movement transversely to the flow direction, therefore a rather complex system form eliminating the scale. The magnetic plates promote the sedimentation of iron oxides. The plates described are thick and have a high distance therebetween.

By denying the usefulness of TPI or CPI-type lamellar packs in the steel or metallurgical sector, the document does not offer any incentive to implement their use to eliminate metal scale from cooling waters coming from circuits connected to the metalworking.

Going against this bias, a mode for successfully applying lamellar filters for removing suspended solids from cooling waters is identified and described herein. The invention does not apply magnetic forces within the lamellar packs, but only Stokes' law on the sedimentation, exploiting the high projected surface of the lamellar packs. The free sedimentation occurs according to Stokes' law, which predicts the terminal falling speed of a spherical particle in a laminar-flow fluid is proportional to the difference in particle and fluid densities and to the square of the particle radius and inversely proportional to the viscosity of the fluid.

By installing lamellar packs in the longitudinal settlers, which in classic treatment plants are located upstream of sand filters for removing suspended solids, it is possible to significantly increase the degree of separation of the solids, to the point of no longer needing sand filters or the like.

The device for extracting solids can be of various kinds, generally working by grip or suction. The gripping devices can, for example, be shovel, spoon, bucket or grab bucket devices. Advantageously, the bucket is fixed to a hoist. Electro-hydraulic managed devices are preferable, but they can of course also be managed in another manner, such as mechanically. The person skilled in the art easily identifies another suitable extraction device.

In a preferred embodiment of the invention, the device configured to extract the solids from said solids collection sector is a magnetic device. A magnetic device is particularly suitable for extracting ferrous particles, with particular utility in the metallurgical or steel industry for extracting metal scale. A magnetic device is intended as a device provided with a magnet.

Advantageously, the solids extraction device is located upstream of the lamellar pack filter above the solids collection sector, in particular a pit. The solids collection sector is preferably located laterally to the filter, in particular upstream of the filter with respect to the liquid flow direction.

Advantageously, the system for conveying the solids leaving the filter is a conveyor belt arranged below the filter, preferably with scraping elements, to collect and detach solids from the bottom and transport them towards the solids collection sector.

In an embodiment of the invention, the sedimentation tank is divided into a first chamber and a second chamber, wherein the first chamber comprises the lamellar pack filter, the solids collection sector and the system for conveying the solids and the first and second chambers are connected to each other by means of a weir to pass the liquid from the first to the second chamber, withdrawing it at the surface through the siphon effect. Single-chamber tanks are also conceivable, from which purified water is withdrawn through relative pumping systems.

Classic lamellar pack filters are conceivable in which the packs are formed by a plurality of essentially parallel, corrugated or smooth slabs, inclined, preferably at an inclination angle of 50° to 65°, known as lamellar packs of the TPI or CPI type.

In fact, particularly satisfactory results have been achieved in terms of the degree of elimination of suspended solids, in particular of metal scale, with a lamellar pack filter comprising a plurality of adjacent, essentially parallel and inclined tubular profiles, in particular with an angle of inclination with respect to the bottom of said tank of 50-65°, in particular of about 60°. The tubular profiles or channels with respect to the succession of slabs greatly increase the sedimentation efficiency.

The sedimentation surfaces which are inclined with respect to the bottom of the tank are therefore the upper surfaces of the inclined slabs or the lower inner surfaces of each tubular profile.

The lamellar separators of the TPI/CPI type or with tubular profiles allow to purify with very high efficiency waters containing suspended solids and at the same time oily substances, and this in sedimentation tanks of reduced size with respect to the classic longitudinal sedimentation tanks usual in the sector, reaching limited overall dimensions. The lamellar pack system, which can be more or less extended, ensures an operating elasticity, both with respect to the variation of the flow rate and with respect to the content of the suspensions. The commissioning is very simple. In fact, it is not necessary to have mechanical moving parts of the lamellar packs themselves or to power them electrically, pneumatically or hydraulically. Maintenance is not demanding; the packs have a long service life.

The system proposed with the invention allows cost savings for civil, assembly, mechanical equipment works of more than 50% with respect to a classic longitudinal settler with the use of a set of sand filters.

The maintenance of the lamellar packs is simple and easy, as the packs are advantageously composed of modular units with an assembly of a given number of profiles which can be joined and assembled in various configurations and extensions. The same modular system makes it easy to extract individual units and clean them, for example with common pressure-washer type appliances.

In a preferred embodiment of the invention, in the device according to the invention said plurality of tubular profiles in cross-section corresponds to a honeycomb structure wherein each tubular profile preferably has a “V” shape. The profiles or tubes representing channels for the passing fluid are preferably equidistant or of equal size and have a unique length of the sedimentation path. The “V” channels facilitate the discharge of sludge.

Preferably they are made of polymeric material, such as polyvinyl chloride (PVC) or polypropylene (PP), and therefore do not require solid supports or containment frames in metal material, for example fibreglass supports are sufficient. Plastic materials allow use in corrosive applications, but also at high temperatures, for example >55° C., can be resistant to UV rays and can be produced with acceptable dimensional tolerances.

Advantageously, the lamellar packs are arranged in sub-units, i.e., with modular elements, as explained above, containing a limited number of profiles, for example joined (in a view from above in the direction of the longitudinal extension of the profiles) in the form of a rhombus provided with male-female elements or interlocking in general to allow an assembly on site, in the required extension. This modular system allows to occupy less space during transport.

The packs are easily adaptable in shape, as in the geometry of the cross section, inclination, length of the profile, in the dimensions of the individual modules. The modular system is adaptable to the most varied forms of tanks and allows assembly without leaving dead zones. The modular assembly also allows for easy disassembly for servicing, cleaning and repair.

In preferred embodiments of the invention, at least one of the following features is realized, preferably a combination of several or all of the following features:
each tubular profile has a passage from 2 to 4 cm, i.e., a profile distance from 40 to 83 mm;
adjacent tubular profiles have walls in common which have a thickness in the order of millimetres;
the hydraulic radius is in the range of 1.5 to 3 cm;
the sedimentation surface is in the range of 6.25 to 13 m²/m³.

The sedimentation surface is defined as the horizontal projection of the surface of the tubular profiles per m³; multiplied by the height of the module, it results in the sedimentation surface for each m² of base surface. The larger the number of tubular profiles per m³ of module or lamellar pack, the larger the sedimentation surface.

Forms of floating lamellar packs are also conceivable.

The hydraulic radius is a parameter in the sizing of channels, pipelines and other elements of hydraulic works. It is generally represented by the letter R and corresponds to the relationship between: the wet area A (in m²) and the wet contour P (in m) or R=A/P.

Advantageously, the lamellar packs are not provided with magnetic elements or surfaces, or in other words the surfaces of the profiles are not magnetic. With respect to the aforementioned state of the art, magnetic surfaces are not necessary to obtain a sufficient sedimentation yield.

In a preferred embodiment of the invention, in particular when the liquid to be treated is a water-oil system, the device further comprises oil skimmers arranged at the top of said tank, in particular above and/or downstream of said lamellar packs. The lamellar pack filter also contributes to the separation of oils and greases, through the coalescing effects of smaller drops of oils.

The device according to the invention can also be applied to lubricants comprising as a liquid phase only oils, from which metal particles, in particular ferrous particles, must be separated. In this case the system does not comprise oil skimmers.

The water treatment line according to the invention comprises, as defined in the first claim, beyond (i) the device for removing suspended solids from liquids, upstream of said sedimentation tank (ii) one or more pre-treatment tanks for separating solids by gravity, optionally provided with one or more devices configured to extract solids, in particular one or more magnetic devices, and/or one or more oil skimmers.

Separation by gravity is understood as a separation which occurs in liquids spontaneously without additional sedimentation aids such as the lamellar pack filter. Due to their higher specific gravity, metal solids descend towards the bottom of a tank where they accumulate. Such separation is suitable for separating larger and heavier solids.

The elements of point (ii) prepare the water to be treated for the sedimentation of the finer solids in the lamellar packs. The water treatment line comprises and is fed by metalworking plants, in particular rolling mills or casting machines, in particular by metalworking plants wherein the cooling fluid is directly sprayed by direct cooling on the metal material or on components in contact with the metals which must be cooled, this normally leads to incorporating the scale formed during the direct processing of the sprayed fluid. Processes or systems from which water to be treated with the device or in the line according to the invention is derived can be, for example but not exclusively, plants of the type QTB (Quenching and Tempering of Bars) or QTR (Quenching and Tempering of Wire Rod, tempering and hardening of rods), pre-finishing units, fast finishing units (FFB, fastfinishing blocks), reheating furnaces (RHF), rolling mills (RM).

Advantageously, in the water treatment line according to the invention, said sedimentation tank is connected downstream (directly) to a tank for redistributing purified liquids leaving said sedimentation tank, to reuse the liquids directly at the exit from said sedimentation tank without further treatment.

The pre-treatment and sedimentation tanks can be made of different materials, such as in metal carpentry, in particular in the case of pre-treatment tanks, or in reinforced concrete, in particular in the case of the sedimentation tank.

In a particularly preferred embodiment of the invention, the water treatment line according to the invention does not comprise filter media through which the fluids are guided to separate solids, in particular it does not comprise sand filters. In other words, it only comprises passive separation devices which work by sedimentation, applying Stokes' law, possibly aided by magnetic systems and/or oil skimmers.

Comparing a classic system with sand filters with the solution according to the invention, which avoids the use of sand filters, allowed by the great efficiency of a longitudinal sedimentation tank provided with lamellar packs which extend advantageously for almost the entire length of the tank, the industrial application of the innovative system is understood. In an example of the classic system, the water coming from the direct cooling of a rolling line is all conveyed together to the “scale pit” where the separation of the coarse and heavy scale is obtained. The water exiting the “scale pit”, still containing the fine and light scale, is pumped to the longitudinal settler of the water treatment plant. In the particle size of the solids, a considerable reduction in the largest size scale can be noticed. The water is pumped from the longitudinal settler and sent to the sand filters from which the suspended solids content is <10 ppm in output. In the case of the invention, the water coming from the direct cooling of the rolling line are all conveyed together to the “scale pit” where the separation of the coarse and heavy scale is obtained. The water leaving the “scale pit”, still containing the fine and light scale, is pumped to the longitudinal settler reduced in size, in which lamellar packs are installed, for example with a distance d between the walls of 40 mm, a width of the plates of 2000 mm and a height of the plates of 2000 mm and a thickness of the plates of 2.5 mm and a water flow rate of 865 m³/h, it is possible to have a suspended solids content <20 ppm and oils and greases <1 ppm, eliminating—for the separation of metal scale—the need for additional sand filters already with plate packs and not necessarily with tubular profiles. The specific speed to be applied is advantageously <0.6 m³/h per m² of projected surface of the lamellar packs.

A further aspect of the invention relates to a method or process for removing solids, oils and greases from the treatment waters comprising the following steps:
(I) treatment waters from plants or metallurgical or steel processes are pre-treated to remove solids, in particular metal scale, by gravity and/or magnetic effect and optionally to remove oils and greases;
(II) the pre-treated waters are passed through a lamellar pack filter with inclined sedimentation surfaces, in particular within a device or a line according to the invention, optionally also subjected in this step before and/or after the passage through the lamellar pack filter to magnetic and/or oil and grease separations;
(III) the water leaving the lamellar pack filter is preferably directly returned to said metal processing plants.

Advantageously, the process according to the invention does not include water filtering, in particular it does not include filtering in sand filters. Advantageously, the solids separated in step (II) fall below the lamellar packs on a conveyor belt, in particular a scraper belt which conveys the solids collected in a pit placed laterally to the lamellar pack filter, from where they are preferably withdrawn with a device configured to extract the solids as defined above, in particular with a magnetic device which extracts the ferrous materials.

In particular cases, in particular in the absence of large and heavy solids, the pre-treatment of step (I) can be waived.

A further aspect of the invention includes the use of the device, line or process according to the invention for purifying water of the cooling circuit of metallurgical or steel plants from suspended solids and/or oils and greases.

A final aspect of the invention involves the use of lamellar pack filters with inclined sedimentation surfaces to separate ferrous scale and possibly ferrous oxides from cooling water or lubricants from steel or metallurgical processes.

The features and advantages disclosed for one aspect of the invention may be transferred mutatis mutandis to the other aspect of the invention.

The industrial applicability is obvious from the moment that removing suspended solids and oils and greases from cooling waters is possible in an efficient manner, with less complex and less expensive systems with respect to the state of the art, which also allow a modular assembly and simplified maintenance.

Said purposes and advantages will be further highlighted during the description of preferred embodiment examples of the invention provided by way of non-limiting example only.

Variant and further features of the invention are the subject matter of the present application. The description of the preferred embodiment examples of the device, line, process and uses according to the invention is given, by way of example and not of limitation, with reference to the attached drawings. In particular, unless specified otherwise, the number, shape, size and materials of the system and of the individual components may vary, and equivalent elements may be applied without deviating from the invention concept.

### BRIEF DESCRIPTION OF THE DRAWINGS

FIG. 1 depicts an embodiment of a sedimentation tank with lamellar packs according to the invention in a longitudinal section.

FIG. 2 depicts two embodiments of configurations for one or more sedimentation tanks in a plant for removing suspended solids and oils/greases from treatment waters in top view.

FIG. 3 depicts in a perspective view an embodiment of a lamellar pack for the sedimentation tank according to the invention.

FIG. 4 depicts three embodiments of layouts for the tubular profiles which are components of the lamellar pack according to FIG. 3 in cross-sections.

FIG. 5 illustrates a plant for removing suspended solids and oils/greases from treatment waters in a metallurgy/steel plant according to the state of the art.

FIG. 6 illustrates an embodiment of a plant for removing suspended solids and oils/greases from treatment water in a metallurgy/steel plant according to the invention.

### DETAILED DESCRIPTION

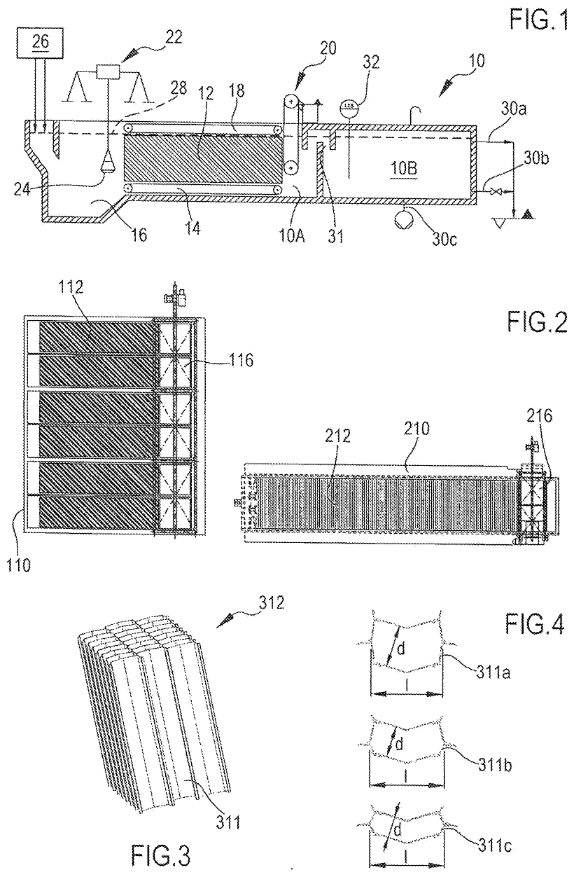

FIG. 1 depicts in longitudinal section an embodiment of a sedimentation tank 10 with lamellar packs 12. Below the lamellar packs 12 is a transport system, preferably a scraper belt 14 for removing solids separated from the lamellar packs 12 towards a conveying area, preferably lowered in the form of a pit 16 arranged in the bottom of the tank 10. A second conveyor system, preferably a belt 18, can optionally be provided above the lamellar packs 12 for conveying oils and/or greases to the oil skimmer 20, alternatively the tank 10 uses only the skimmer 20. The solids accumulated in the pit 16 consist mainly of metal scale which is extracted with a hoist 22 provided with a bucket 24. The scale accumulates in the pit 16 also by gravity when the water containing the suspended solids comes from different sources 26 in the tank 10. The water after the passage of the lamellar packs 12 and the removal of lighter oils and greases from the water from the surface 28 of the fluid is transferred through a weir 31 with siphon effect from a first chamber 10A to a second chamber 10B of the tank 10. From this chamber 10B, the clean water can be discharged at different levels 30a, 30b and 30c to be released into the ground or be pumped to further treatments and/or reuse as a cooling fluid in the metal processing plants from which the water being treated in the tank 10 originated. A level gauge 32 serves to indicate the water level in the tank 10.

FIG. 2 depicts two configurations for one or more sedimentation tanks as can be included in a plant for removing suspended solids and oils/greases from treatment waters in top view. Such configurations can respond to different capacity needs and/or spaces available within the plants with the use of cooling water which must then be subjected to treatment in the tanks. On the left is a series of sedimentation tanks 110 made of metallic carpentry and arranged in parallel with the relative lamellar packs 112 and the pits 116 for the collection of the separated scale. In the image on the right, instead, a single elongated tank 210 made of reinforced concrete with relative pit 216 and lamellar packs 212 can be seen. The variation of the geometry of the configurations, the number and dimensions of the tanks is facilitated by the fact that the lamellar packs can be assembled in modular form by a plurality of lamellar pack base units.

FIG. 3 depicts a perspective view of a lamellar pack 312 for a sedimentation tank. The lamellar pack 312 is composed of a plurality of adjacent profiles 311 which share a same wall along adjacent surfaces. The individual profiles 311 are combined without gaps between one profile and the other; each profile represents a channel for the passage of the fluid being settled.

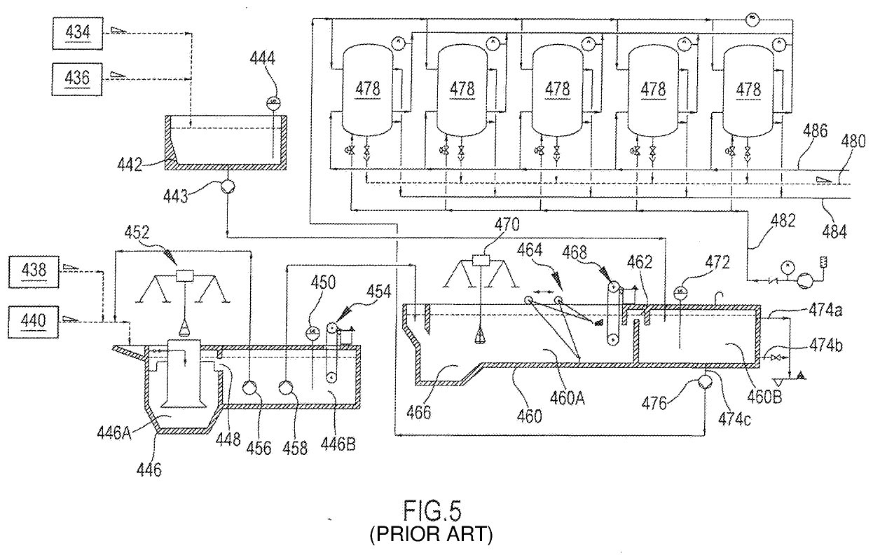

FIG. 4 depicts three exemplary layouts for the profiles 311 a-c, which compose a lamellar pack according to FIG. 3, in cross-sections. All the profiles 311 a-c have in a preferential shape a “V” section which mimics a slide and favours the directing of the solids towards the tip of the “V” and in accordance with the more or less inclined arrangement of the profiles 311 a-c with respect to the bottom of the tank a downwards sliding thereof. The individual profiles from top to bottom are distinguished by the distance d between the walls and the maximum width 1 of the profiles 311 a-c, allowing to vary the number of profiles per sectional area and the surface available for sedimentation per m³. Obviously it is also possible to vary the length of the profiles 311 a-c and therefore the height of the relative lamellar pack.

FIG. 5 shows a plant for removing suspended solids and oils/greases from treatment waters which can be integrated in a metallurgy/steel plant according to the state of the art. From different metal processing plants, for example but not exclusively a bar quenching and tempering plant 434, a rod quenching and tempering plant 436, a reheating furnace 438 and a rolling mill 440, but also casting machines or other, cooling fluids emerge, in particular water dirty with oils and greases from lubrication and scale from the surface oxidation of metal objects, such as strips, bars, slabs, wires, rods etc.; the scale concentrates in particular in the cooling waters which are directly sprayed on the metal objects or on components in contact therewith such as the laminating rollers. From the processing devices 434 and 436 the dirty water with fine scale is directed to a recovery tank 442 with a water level meter 444 where the fine scale remains suspended in the tank 442 and recovered together with the water to the next tank 460B for the sand filtration treatment 478. The treatment waters from the processing devices 438 and 440 instead reach a pre-treatment tank 446 divided into two chambers 446A and 446B separated by a weir 448. A level gauge 450 detects the water level in the tank 446B. In the first chamber 446A, the largest scale that can be withdrawn with a relative electro-hydraulic bucket 452 fall by gravity. In the second chamber 446B, an oil skimmer 454 removes the oil from the surface. A first pump 456 withdraws water to be reintroduced to a new treatment in the first chamber 446A. A second pump 458 withdraws water to feed a longitudinal sedimentation tank 460, also divided into a first chamber 460A and a second chamber 460B connected by a weir 462 which allows a passage of surface water thus avoiding the passage of heavier elements possibly contained in the water which descend by gravity towards the bottom. In the first chamber 460A the heavier solids are deposited on the bottom. A translatable scraping device 464 scrapes the solids from the bottom and pushes them into the pit 466. An oil skimmer 468 removes oils and greases from the water. An electro-hydraulic bucket 470 removes the ferrous solids from the pit 466. The water thus deprived of oils and greases and of the larger scale passes to the surface, thus without heavy solids descending, through the weir 462 in the second chamber 460B. A level gauge 472 is included in the second chamber 460B. As described for the tank of FIG. 1, the water can be withdrawn from the second chamber at different levels 474 a-c, to be used for different applications or destinations. In the specific case, the bottom water still comprising sludge, i.e., finer solids which could not be separated in the longitudinal tank 460 are pumped with a relative pump 476 into a set of sand filters 478 to be filtered. The filtered water is conveyed with a relative network of pipes 484 leading to different applications or further processing, as it can be intended for the soil. For example, it can also be returned to the starting devices where it is again used to cool metal objects. The sand filters 478 become clogged over time due to the fouling which forms on the sand. They require a regeneration which occurs by introducing rinsing water through a relative supply network 486 from the bottom to the top, it is also possible to introduce an airflow 482. The washing water is then removed from the filters 478 through a relative drainage network 480 and can be subjected to cleaning steps, such as sludge treatment. The water thus cleaned can for example also be used for backwashing and introduced through relative lines 486 into the filters 478.

From the pre-treatment tank 442 the water can be directly passed with a relative pump 443 into the second chamber 460B of the longitudinal sedimentation tank 460.

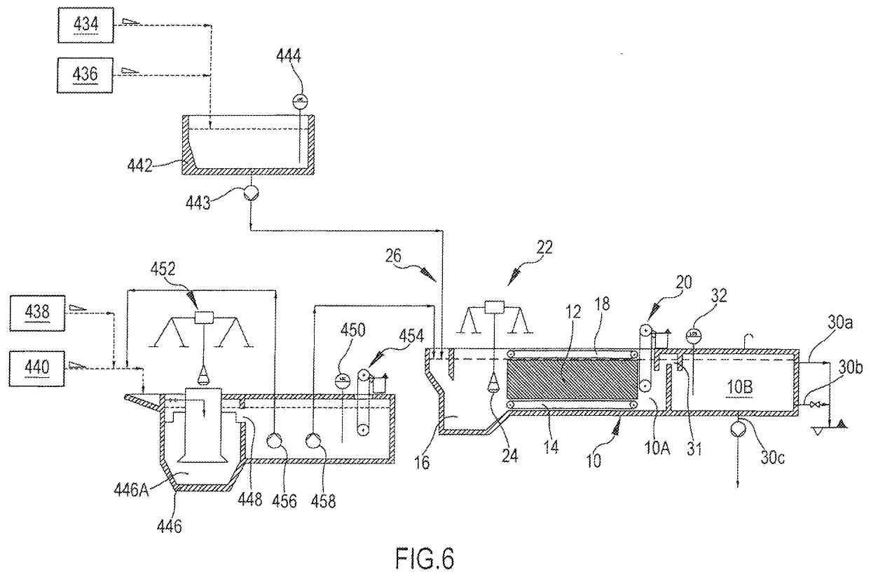

FIG. 6 illustrates a plant for removing suspended solids and oils/greases from treatment waters from metallurgy/steel plants according to the invention. The left part of the plant corresponds to that of the state of the art of FIG. 5, equal reference numbers describe equal elements. Unlike the state-of-the-art system, the set of sand filters is completely missing, resulting in a huge saving of space. Also the sedimentation tank 10, which here corresponds to the one depicted in FIG. 1, has changed, it can be made with smaller dimensions with respect to that 460 of FIG. 5. There is always the hoist 22 with the electro-hydraulic bucket 24 which withdraws metallic/ferrous solids accumulated in the pit 16, there is an oil skimmer 20, the division of the tank 10 into two chambers 10a and 10B with a level meter 32. The two chambers 10a, 10B communicate through a weir 31. But unlike the longitudinal sedimentation tank of FIG. 5, the first chamber is not a simple gravity sedimentation chamber, but comprises the lamellar packs 12 which separate solids suspended in the water by sedimentation as described. The settled solids leaving the lamellar packs fall on the scraper belt 14 which transports them into the pit 16, as described above. The water leaving the water recovery tank 442 with fine scale here is not directed to the second chamber of the sedimentation tank 10B, but subjected to the treatment with lamellar packs 12 in the chamber 10a. The water deprived of solids in the tank 10 unlike the tank 460 can be directly reused in metallurgical plants 434, 436, 438, 440 or introduced into the ground or intended directly for other applications without further treatment; it is possible to completely avoid further treatment with sand filters.

1) A water treatment line comprising:
(a) a device for removing suspended solids from liquids, in particular from water comprising:
(a-1) a sedimentation tank with a solids collection sector;
(a-2) in said tank a lamellar pack filter with sedimentation surfaces inclined with respect to the bottom of said tank;
(a-3) in said tank a system for conveying the solids leaving said lamellar pack filter into said collection sector; and
(a-4) a device configured to extract the solids from said solids collection sector,
(b) upstream of said sedimentation tank one or more pre-treatment tanks for separating solids by gravity, optionally provided with one or more devices configured to extract solids, in particular one or more magnetic devices, and/or one or more oil skimmers, and
(c) metal processing plants, in particular rolling mills or casting machines, quenching or tempering machines, pre-finishing or finishing machines, wherein preferably the cooling fluid is directly sprayed on the metal material, and wherein said metal processing plants feed said water treatment line and are located upstream of said device for the removal of suspended solids from liquids and of said one or more pre-treatment tanks;
wherein the lamellar pack filter comprises a plurality of adjacent, essentially parallel and inclined tubular profiles.

2) The water treatment line according to claim 1, wherein said plurality of tubular profiles in cross-section corresponds to a honeycomb structure in which each tubular profile has a “V” shape.

3) The water treatment line according to claim 1, wherein the hydraulic radius is in the range between 1.5 and 3 cm.

4) The water treatment line according to claim 1, wherein the sedimentation surface is in the range between 6.25 and 13 m²/m³.

5) The water treatment line according to claim 1, wherein the lamellar packs do not have any magnetic elements or surfaces.

6) The water treatment line according to claim 1, wherein said device for the removal of suspended solids from liquids further comprises one or more oil skimmers arranged in the upper part of said sedimentation tank.

7) The water treatment line according to claim 1, wherein said lamellar packs are composed of modular units with an assembly of a given number of tubular profiles.

8) The water treatment line according to claim 1, wherein said device configured to extract solids from said solids collection sector is a magnetic device.

9) The water treatment line according to claim 1, wherein said sedimentation tank is connected downstream to a basin for redistributing of the liquids leaving said sedimentation tank to users using the purified liquid without further passage through cleaning devices.

10) The water treatment line according to claim 1, wherein said water treatment line excludes filter media through which fluids are guided to separate solids, in particular said water treatment line excludes sand filters.

11) A process for removing suspended solids from treatment waters comprising the following steps:
(I) pre-treating treatment waters from metallurgical or steel plants or processes to remove solids, in particular metal scale, by gravity and/or magnetic effect and optionally to remove oils and greases;
(II) passing the pre-treated waters through a lamellar pack filter with inclined sedimentation surfaces, within the water treatment line according to claim 1; and
(III) directly returning the waters leaving the lamellar pack filter to said metal processing plants.

12) A method of using lamellar pack filters with inclined sedimentation surfaces, wherein each lamellar pack filter comprises a plurality of adjacent, essentially parallel and inclined tubular profiles, in particular with an angle of inclination with respect to the bottom of said sedimentation tank of 50-65° for separating ferrous scale and ferrous oxides from cooling waters or from lubricants coming from steel or metallurgical processes, comprising the steps of:
pre-treating treatment waters from metallurgical or steel plants or processes to remove solids, including metal scale, by gravity and/or magnetic effect and to remove oils and greases; and
passing the pre-treated waters through said lamellar pack filters with inclined sedimentation surfaces,
wherein the waters leaving the lamellar pack filters are directly returned to said metal processing plants.

13. The water treatment line according to claim 1, wherein the plurality of inclined tubular profiles have an angle of inclination with respect to the bottom of said sedimentation tank of 50-65°.

14. The process of claim 11, wherein the step of passing further comprises subjecting the pre-treated waters to magnetic and/or oil and grease separations, before and/or after the passing of the pre-treated waters through the lamellar pack filters.
